(19) United States
(12) Patent Application Publication
(10) Pub. No.: US 2003/0153708 A1
(43) Pub. Date: Aug. 14, 2003

(54) Free radical retrograde precipitation copolymers and process for making same

(76) Inventors: Gerald Tablada Caneba, Houghton, MI (US); Yadunandan L. Dar, Somerville, NJ (US)

Correspondence Address: Thomas F. Roland, NATIONAL STARCH AND CHEMICAL COMPANY, P.O. Box 6500, Bridgewater, NJ, 08807-0500, US

(21) Appl. No.: 10/045,725

(22) Filed: Jan. 11, 2002

(51) Int. Cl. C08F 120/06

(52) U.S. Cl. 526/317.1; 526/346; 526/319; 526/303.1; 526/341; 526/330

(57) ABSTRACT

The present invention is directed to a single stage free radical precipitation polymerization process for producing a copolymer involving admixing a solvent, a free-radical-forming agent, (meth)acrylic acid, and at least one monomer selected from the group consisting of styrene, vinyl acetate, methylmethacrylate, butyl acrylate, methyl acrylate, acrylonitrile, and isopropylacrylamide; initiating a free-radical precipitation polymerization to form a plurality of polymer radicals; precipitating a polymer from said polymer radicals; maintaining the admixture of reactants at a temperature above the lower critical solution temperature of said admixture; and controlling the temperature of said admixture to control the rate of propagation of the polymer. The process is useful for producing random copolymers of vinyl acetate or styrene with more than 4 percent and up to greater than 20 percent by weight of (meth)acrylic acid.

### FIELD OF THE INVENTION

The invention relates to a single stage free radical retrograde precipitation polymerization process (FRRPP) for producing a copolymer. The process is useful for producing both block and random copolymers. In particular random and block copolymers of vinyl acetate or styrene with more than 4 percent (meth)acrylic acid may be synthesized using the process.

### BACKGROUND OF THE INVENTION

Free radical polymerization is a preferred technique for the synthesis of many polymers. One drawback of free radical polymerization is the lack of control of the resultant polymer structure. The type and amount of initiator, temperature, and delayed monomer feeds have all been used to control the final structure and size of the polymer particles.

Living polymers offer some control of the polymer structure. Living polymers are polymers having at least one active radical on the polymer chain (non-terminated polymer chain). Most commonly, living radicals are formed by anionic polymerization in non-polar solvent, or involve a capping-mechanism to stop the growing radical, then restarting the polymer growth by removal of the cap.

“Low VOC Latex Paints from a Precipitation Polymerization Process”, Clean Prod. Processes, 3 (2001), 5-59 discloses the formation of a methyl methacrylate/butyl acrylate copolymer from a conventional precipitation reaction using n-heptane as the solvent. The resulting dispersion is bimodal. A problem with conventional precipitation polymerization is that conversion rates are generally very low, requiring a relatively expensive procedure to isolate the polymer and recycle monomer.

U.S. Pat. No. 5,173,551 and “Studies of the Polymerization of Methacrylic Acid via Free-Radical Retrograde Precipitation Polymerization Process”, J. Applied Polymer Science, Vol. 62, 2039-2051 (1996) describe the use of a free-radical retrograde polymerization process as a means of controlling the molecular weight distribution of the polymer particles. In this process a monomer mixture in a solvent is initiated by a solvent-soluble free radical initiator to produce polymer radicals that precipitate into polymer-rich phases in a solvent.

Random copolymers of (meth)acrylic acid with monomers such as styrene and vinyl acetate are difficult to produce by free radical polymerization, since (meth)acrylic acid has a much higher reactivity that the styrene or vinyl acetate monomer. Random copolymers with more than 5 percent (meth)acrylic acid content are not produced in an efficient manner.

Surprisingly it has been found that a random copolymer of vinyl acetate and acrylic acid, having significantly more than 5 percent acrylic acid could be produced under practical operating conditions.

### SUMMARY OF THE INVENTION

The present invention is directed to a copolymer comprising from 5 to 50 percent by weight of (meth)acrylic acid units; and from 50 to 95 percent by weight of vinyl acetate or styrene monomer units.

The invention is also directed to a single stage free radical retrograde precipitation polymerization process for producing a copolymer comprising:

a) admixing

1) a solvent,

2) a free-radical-forming agent,

3) (meth)acrylic acid (MAA or AA),

4) and at least one monomer selected from the group consisting of styrene (S), vinyl acetate (VA), methylmethacrylate (MMA), butyl acrylate (BA), methyl acrylate (MA), acrylonitrile (AN), and N-isopropylacrylamide (NIPAAm);

b) initiating a free-radical precipitation polymerization to form a plurality of polymer radicals;

c) precipitating a polymer from said polymer radicals;

d) maintaining the admixture of reactants at a temperature above the lower critical solution temperature of said admixture; and

e) controlling the reaction conditions of said admixture to control the rate of propagation of the polymer.

Finally, the invention provides a means of obtaining monomer sequences in the copolymer that are different from those obtained from conventional monomer reactivities.

### BRIEF DESCRIPTION OF THE DRAWINGS

FIG. 1 is a plot of the conversion-time behavior for styrene-acrylic acid copolymerizations of Examples 1 and 4. The solution system reached an asymptote after four initiator half lives, indicating the termination of radicals. The FRRPP system still had conversion increasing.

FIG. 2 compares the UV and RI-based number average molecular weights for both the FRRPP process and the solution process from Examples 1 and 5.

FIG. 3 plots the kinetic data from the copolymerization of vinyl acetate and acrylic acid of Example 6. Note that the initiator (VA-044) has a half-life of 30 minutes at the operating temperature of 65° C.

FIG. 4 plots ternary phase diagram of ammonia-neutralized B6-1 VA/A product in water and 17 wt % styrene in t-butyl acetate. The two-phase region is the portion of the envelope that is between the data points and the diagonal. Also, regions of B6-1 concentrations above 6 wt % have not been investigated.

FIG. 5 plots the kinetic data for the Example 8 experiment.

### DETAILED DESCRIPTION OF THE INVENTION

Free radical retrograde precipitation polymerization, as used herein, is a chain polymerization process where vinyl-type monomers are reacted with free radicals in a solution environment, which forms an immiscible polymer-rich phase when a minimum amount of polymer of a minimum size is produced (phase separation or precipitation). In a conventional precipitation polymer process a miscible polymer solution becomes phase separated when the temperature is lowered. In a retrograde polymer solution system, phase separation occurs when the temperature is increased to above a lower critical solution temperature (LCST), which is the minimum temperature phase separation could occur. This type of free radical retrograde precipitation polymerization is described in U.S. Pat. No. 5,173,551, incorporated herein by reference.

By “copolymers”, as used herein, is meant a polymer produced from at least two different monomers. The copolymer may be a pure block copolymer, a tapered block copolymer or a random copolymer. A Pure block copolymer is one consisting of a large block of one type of monomer unit, and a large block another type of monomer unit. A tapered-block copolymer is one having blocks of one monomer unit, followed by blocks of another monomer unit—where the size of the blocks of one monomer unit are large on one end of the polymer and gradually become smaller toward the other end, as blocks of the second monomer gradually become larger.

The process of the present invention can be advantageously employed to produce an unexpectedly high yield of narrow molecular weight distribution free-radical based copolymers The copolymers of the present invention contain at least one (meth) acrylic acid unit and at least one other ethylenically unsaturated monomer unit. As used herein, (meth)acrylic acid is used to mean acrylic acid, methacrylic acid, or a mixture thereof. The copolymer contains at least 4 percent by weight, preferably at least 10 percent by weight, more preferably 15 percent by weight of (meth)acrylic acid units. Copolymers having over 30 percent by weight of acrylic acid were produced by the method of the invention. While not being bound by any theory, it is believed that the FRRPP process provides a flexibility in the control of the reaction which allows one to surmount the problem of fast reactivity of (meth)acrylic acid compared to the second monomer.

The copolymer will also contain at least one non-acid ethylenically unsaturated monomer unit. The non-acid ethylenically unsaturated monomer may be, but is not limited to, styrene, vinyl acetate, methyl methacrylate, butyl acrylate, methyl acrylate, acrylonitrile, isopropylacrylamide, and mixtures thereof. Vinyl acetate and styrene are especially preferred as comonomers.

Preferably, the monomers used in the present process are purified or processed in a manner sufficient to potentially minimize the presence of free radical scavengers in the admixture of reactants.

The solvent used in the process is selected such that the polymer-rich phase of the admixture that ensues during polymerization can be maintained in the reactor system at a temperature above the Lower Critical Solution Temperature (“LCST”) of the admixture. By “LCST” as used herein is meant the temperature above which a polymer will become less soluble in a solvent/polymer admixture as the temperature of the admixture is increased. Also, the solvent is preferably such that the viscosity of a resulting polymer-rich phase is suitable for mixing. Additionally, the solvent is preferably such that its employment will help minimize the amount of free-radical scavengers that may be present in the admixture of reactants. Solvents useful in the present process include, but are not limited to, organic and inorganic solvents such as acetone, methylethylketone, diethyl-ether, n-pentane, isopropanol, ethanol, dipropylketone, n-butylchloride and mixtures thereof. Useful mixed solvent systems include, but are not limited to, ethanol/cyclohexane, water/methyl ethyl ketone, water/higher ketones such as water/2-pentanone, water/ethylene glycol methyl butyl ether, water propylene glycol propyl ether, glycerol/guaiacol, glycrol/m-toluidine, glycerol/ethyl benzylamine, water/isoporanol, water/t-butanol, Iwater/pyridines, and water/piperidines. For a purely organic system, methanol can be substituted for water in the preceding list of mixed solvents. The solvent is also preferably employed in its fractionally distilled form. In particular, some preferred copolymer/solvent systems for FRRPP polymer formation include, for example, vinyl acetate/acrylic acid with azeotropic t-butanol/water; methylmethacrylate/acrylic acid with azeotropic t-butanol/water; and styrene/acrylic acid with ether.

A free-radical generator is used for initiation of the polymerization. Free radicals are generated to initiate polymerization by the use of one or more mechanisms such as photochemical initiation, thermal initiation, redox initiation, degradative initiation, ultrasonic initiation, or the like. Preferably the initiators are selected from azo-type initiators, peroxide type initiators, or mixtures thereof. Examples of suitable peroxide initiators include, but are not limited to, diacyl peroxides, peroxy esters, peroxy ketals, di-alkyl peroxides, and hydroperoxides, specifically benzoyl peroxide, deconoyl peroxide, lauroyl peroxide, succinic acid peroxide, cumere hydroperoxide, t-butyl peroxy acetate, 2,2 di (t-butyl peroxy) butane di-allyl peroxide), cumyl peroxide, or mixtures thereof. Examples of suitable azo-type initiators include, but are not limited to azobisisobutyronitrile (AIBN), 2,2′-azobis (N,N′-dimethyleneisobutyramide) dihydochloride (or VA-044 of Wako Chemical Co.), 2,2′-azobis(2,4-dimethyl valeronitrile) (or V-65 of Wako Chemical Co.), 1,1′-azobis (1-cyclohexane carbonitrile), acid-functional azo-type initiators such as 4,4′-azobis (4-cyanopentanoic acid). Highly preferred free-radical-forming agents of the present invention are AIBN, V-65, and VA-044.

The initiator is introduced into the system either by itself or having already been admixed with solvent or monomer. Preferably, the initiator is introduced into the reactor system already having been admixed with the monomer.

The process of the present invention is used to produce copolymers having a weight average molecular weight range of 1,000 to 100,000, with narrow molecular weight distributions.

A reactor system for practicing the process of the present invention is described in U.S. Pat. No. 5,173,551. A system which is useful in the practice of the present invention consists of a stirred tank reactor having a stirrer capable of providing agitation at 300 to 600 rpm; a temperature sensor/probe; a means of heating and cooling the reactor and its contents, and a controller to maintain or adjust the temperature of the reactor contents; a means of providing an inert gas into the reactor; a reservoir for holding an admixture of one or more of solvent, monomer, and initiator; and a pump or other means for moving the contents of the reservoir to the reactor. The reactor may also be fitted with a reflux condenser. One of skill in the art will be able to apply the method of the present invention to other reactor systems including other batch reactor systems, semi-batch reactors, and tubular reactors.

The process of the present invention is a single stage process in which the polymerization is carried out with simultaneous presence of two or more monomers, as opposed to a multi-stage system in which all monomer in the system is depleted (polymerized) prior to adding a second monomer.

Preferably, from 0 to about 90 percent by volume of the reactor is filled with solvent. The reactor and solvent are heated to one or more predetermined temperatures. The process is preferably run at atmospheric pressure. An initiator/monomer admixture, or solvent/initiator/monomer admixture is added to the reactor, either as a single charge, or in a delayed feed over a period of from 0 to 1,000 minutes.

The initiator preferably is introduced at a proportion ranging up to 15,000 milligrams of initiator per milliliter of monomer, and more preferably up to about 100 milligrams initiator per milliliter of monomer. The amount of solvent is preferably of about the same general order of magnitude as the monomer. However, it may be more or less depending upon factors such as the particular operating conditions and kinetics desired, and the characteristics desired in the final polymer.

In addition to solvent, monomer and initiator, other minor constituents as known in the art may also be included in the admixture. Care is taken to minimize the presence of scavenger constituents that might inhibit the desired free radical reactions capable within the present preferred system. To help minimize the presence of undesired scavengers in the admixture of reactants one or more of following steps are preferably performed: (1) removing inhibitor that may be present initially in the monomer by extraction with a caustic solution, followed by extraction of excess caustic material with distilled water and vacuum fractional distillation, or by passing the monomer through an ion exchange resin column; (2) bubbling nitrogen gas for a predetermined amount of time through the admixture of reactants; or (3) blanketing the reactor chamber with a substantially non-reactive gas, such as nitrogen, preferably at a pressure greater than that of the solvent vapor pressure.

After the reactants are introduced into the reaction chamber, the reaction chamber is heated with a slow nitrogen gas sweep on the vapor space; a polymerization reaction is initiated in a suitable manner; and the reactants are allowed to react (to precipitate a polymer) at a substantially constant temperature and pressure for a predetermined amount of time.

Termination of precipitated polymer radicals can be accomplished by one or more steps such as reducing the temperature of the reaction chamber; adding a suitable solvent for the resulting polymer; adding a suitable chain transfer agent (e.g. a mercaptan type agent) to the system; introducing a suitable radical scavenger (e.g. oxygen from air); or by vaporizing some of the solvent in reactor.

The type of copolymer desired, block, tapered block, or random copolymer can be controlled by reaction conditions. A block or tapered block copolymer can be formed by the addition of all or most of the monomer/free radical generator admixture with the initial charge. A random copolymer can be formed by a delayed and/or continuous feed of the monomer and initiator admixture. The capability shown in the present invention to produce these materials from single-stage free-radical copolymerization chemistry are not normally possible in conventional bulk, solution, dispersion, suspension, emulsion, and precipitation environments. Thus, the present invention makes the claim for the capability to affect monomer sequences in copolymers in ways that are not possible from conventional single-stage copolymerization methods.

If homopolymer radicals can be maintained in an FRRPP system based on the reduction of the propagation rate, then it is possible to manipulate the effects of relative reactivity ratios in copolymerization kinetics. The inclusion of a minor amount of acrylic acid (5-7.5 wt % AA charge relative to monomers) in the first-stage monomer will result in the initial formation of acrylic acid-rich copolymer. This is borne by the fact that the average reactivity ratios for AA (1) and S (2) are: r₁=0.21 and r₂=0.33 (Brandrup, J., Immergut, E.H., and Grulke, E. 1999, “Polymer Handbook”, John Wiley and Sons, 4th Edition, New York.), and that poly(acrylic acid) precipitates in ether below the upper critical solution temperature (UCST). Thus, there is precipitation-enhanced reaction of AA to styrene-radical ends and S to AA-radical ends, and the precipitation of poly(acrylic acid) below the UCST enhances the addition of AA to S-radical ends compared to addition of S to AA-radical ends. At the same time, the presence of styrene in the chain could result in the reduction of bimolecular termination. When a significant fraction of acrylic acid has reacted, continued addition of styrene in the chains can occur, producing a tapered block copolymer. Even though there is still AA left in the reactor, reactive sites of the tapered blocks are trapped-in by retrograde-precipitation/reaction-kinetics. Thus, most of the remaining AA will react with newly-formed primary radicals.

In the first stage of the FRRPP process (formation of homopolystyrene in ether), it is evident that live radicals are formed. The best estimate of the proportion of live radical species is in the order of 80 percent relative to all polymer molecules/radicals. The biggest stumbling block in continued propagation from the FRRPP system is the agglomeration of polymer-rich domains into relatively large sizes. A promising approach is to rapidly cool the reactor fluid, after a time period of at least 3 times the initiator half life, to produce in order to redistribute monomer molecules while minimizing propagation and termination. Then, propagation is continued and brought under control by rapidly raising the system temperature above the LCST. This is called an interstage rapid cooling procedure.

The process of the present invention is useful in producing copolymers having monomer sequences not normally possible based on monomer reactivities. An example of such a copolymer is one having acrylic acid (reactivity of 8.66) and vinyl acetate (reactivity 0.021). This means that from a reactivity standpoint, AA-radical ends will want to react with AA monomer. This implies a very active AA monomer, making it difficult to produce a VA/AA copolymer having levels of AA approaching 4 percent or greater. The reactivity of AA monomer would normally result in AA-rich chains, and AA-poor chains. If the introduction of AA in the reactor is controlled, then the reaction of VA will allow the overall control of the propagation rate while keeping polymer radicals live. This will result in the possibility of producing relatively high AA-content copolymers. A similar situation is encountered with a SNA system, where the S reactivity ratio is 55 and the VA reactivity ratio is 0.01 (Odian, G., “Principles of Polymerization”, 2^{nd} Ed., John Wiley and Sons, New York, 1981, Chapter 6). This can be generalized to the situation wherein one of the monomer reactivity ratios is relatively large (up to a practical limit of 100, and a theoretical limit of 1000), while the other one is close to zero. Another set of monomers is styrene-maleic anhydride, which both have reactivity ratios close to zero. Under normal circumstances (in solution or bulk polymerization conditions), the result is an alternating copolymer. If the reaction is carried out in such a way that the poly(maleic anhydride) phase separates above the LCST in the fluid system, then a reaction fluid with relatively large styrene-to-maleic anhydride ratio will result in a solid comprising a polystyrene that is blocked with an alternating copolymer of styrene and maleic anhydride. Going to the other extreme where both reactivity ratios are relatively high (up to a practical limit of 100, and a theoretical limit of 1000), the normal result is a homopolymer blend. However, if the polymer system phase separates above the LCST and the reaction is carried out whereby one monomer is in large excess compared to the other, then the polymer radicals that are formed can be recombined to form a block copolymer. All the above-mentioned cases point to the applicability of this invention to systems with combinations of reactivity ratios between zero and relatively high values.

Copolymers of the present invention may be useful in many application, including as surfactants, emulsifiers, coatings, surface cleaning agents, water-dispersible or biodegradable adhesives, fibers, foams, films, dispersants, thickeners, and as interfacial agents for wood, PVC, polyurethane, paper and textiles.

The presence of (meth)acrylic acid (especially in neutralized form) provides the copolymer with water dispersibility. Additionally the polyvinyl acetate can hydrolyze slowly in the environment to form polyvinyl alcohol segments, which can lead to at least partial biodegradability.

One of skill in the art could envision a universal surfactant with a range of HLB numbers from VA/AA copolymers. Surfactancy increases when the acid is neutralized—especially with ammonia in water. The existence of vinyl acetate groups on a polymeric surfactant as the hydrophobic entity provides affinity to many polar hydrophobic materials. If one looks at the book on emulsifiers and surfactants, it is evident that there are only a few chemical types of hydrophobic groups, such as methylene, ether, silicones, phenyl, ethoxy, ester groups (McCutcheon's Emulsifiers and Detergents, 1998). In the area of polymer surfactants, the list of hydrophobic groups narrows to ether, methylene, and silicone types. VA polymer groups in a surfactant system will definitely be unique, and have more affinity to more polar hydrophobic materials.

On the hydrophilic end, AA-rich blocks from a distribution of sizes offer better performance in a number of areas. This can translate to better emulsifying capabilities because of better packing of various-sized micellar domains. Also, a surfactant with varying hydrophilic molecular sizes can be used efficiently in dispersion of materials with a size distribution.

It has been found that the vinyl acetate/acrylic acid copolymers of the present invention are capable of being blown into a foam. The blowing capacity appears to increase with increasing VA content. Since the copolymers have a semi-crystalline nature, they could be formulated as a blown film. The copolymer can also be drawn into a fiber when spun from a coagulum of the copolymer solution in potassium hydroxide water, suggesting that the copolymer may have applicability in fiber applications.

The following examples are presented to further illustrate and explain the present invention and should not be taken as limiting in any regard.

### EXAMPLE 1-5

### Single Stage FRRPP Process for S/AA Copolymer

Copolymers of styrene and acrylic acid (S/M) were polymerized in ether (FRRPP) using the following basic recipe:

Example 1: 100 g ether, 0.3 g V-65, 30 g monomers. All fluids used were purged with nitrogen gas by bubbling the gas for at least 15 minutes. At the outset, 80 g diethyl ether and 1 g AA were fed into a 300-ml Parr reactor system at room temperature. The reactor fluid was raised to its operating temperature of 80° C. Then, 0.5 g AA, 28.5 g S, and 0.3 g V65 were pumped into the reactor in 28-35 minutes to start the polymerization.

Example 2: The reaction was run as in Example 1, but at a temperature of 60° C.

Example 3: The reaction was run as in Example 1, using a total of 3 g of AA and 27 g of styrene.

Example 4 (Comparative) The reaction was run as in Example 1, using pyridine as the solvent rather than diethyl ether. Pyridine is a solvent for both polystyrene and poly (acrylic acid), therefore a solution polymerization, rather than an FRRPP occurs.

Example 5, (Comparative) The reaction was run as in Example 3, using 3 g of AA and using cyclohexane as the solvent rather than diethyl ether. Cyclohexane is a conventional precipitation polymerization solvent with respect to poly(acrylic acid) and a solution polymerization solvent with respect to polystyrene.

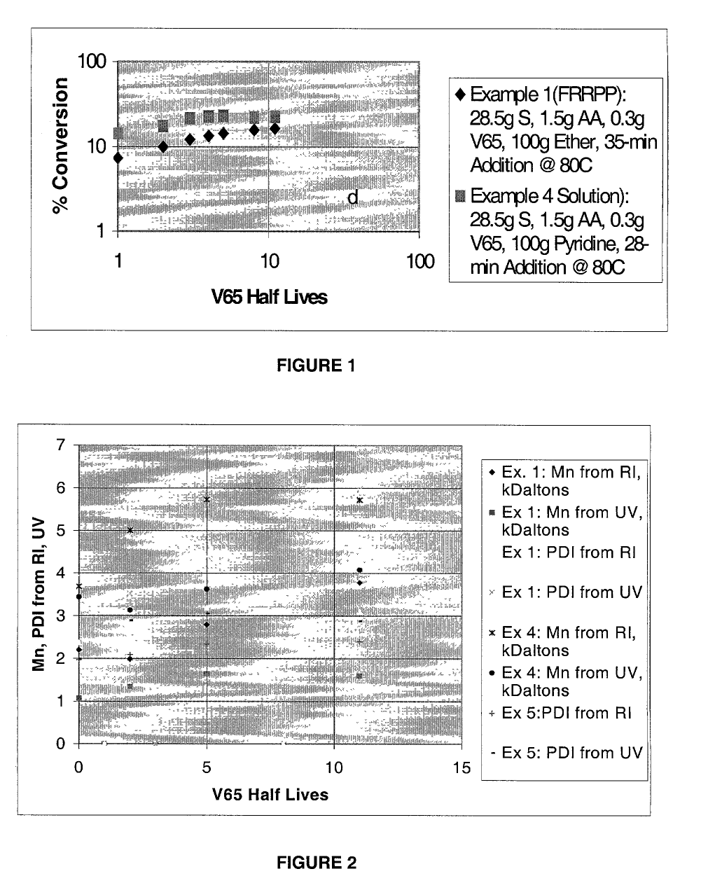

FIG. 1 shows conversion-time behavior for S/AA copolymerization after the reactive mixture was pumped in. In both solution and FRRPP systems, conversions never reached 100%. The solution system reached an asymptote after four initiator half lives, indicating the termination of radicals. The FRRPP system still had its conversion increasing almost linearly in the log-log plot.

In FIG. 2, one can see that after five V65 half lives UV-based number average molecular weight remained steady for the FRRPP system (Example 1), while the value is still increasing for the solution system (Example 4). At the same time, RI-based number average molecular weight were increasing for both FRRPP and solution systems. This means that indeed styrene polymerization is under good control in Example 1, while AA polymerization is not well-controlled.

Tables 1 and 2 below show results of molecular weight analysis, and their comparison with conversion and Wt % AA data. AA contents were obtained using ¹H-NMR methods with pyridine-d5 as solvent.

TABLE 1
GPC and other kinetic results of PS-PAA samples from the 100 g DEE (Example 3) or
Cyclohexane (Example 5), 0.3 g V65, 3 g AA, 27 g S recipe

| | | | | | Number | Number |
|---|---|---|---|---|---|---|
| | | | | | Average | Average |
| Number of | | | Number | | MW from | MW from |
| of | Wt % | | Average MW | Wt % AA | RI, kD | UV, kD |
| Initiator | AA in | Number Average MW | from UV, kD | in Solid | (PDI) | (PDI) |
| Half | Solid | from RI, kD (PDI) | (PDI) | Solvent - Cyclohexane | | |
| Lives | Solvent - Ether (Example 3) | | | (Example 5) | | |
| 0 | | | | | | |
| 1 | 43 | 2.63 (2.28) | | 22 | 9.449 | 8.736 |
| | | | | | (1.97) | (2.11) |
| 2 | 30 | | | | | |
| 3 | 21 | | 2.16 (2.99) | 26 | 11.041 | |
| | | | | | (1.95) | |
| 4 | 27 | | | | | |
| 5 | 22 | 3.73 (2.35) | 2.33 (3.10) | 32 | 13.966 | 8.681 |
| | | | | | (1.92) | (2.93) |
| 8 | 27 | | | | | |
| 11 | 26 | 4.31 (2.71) | 2.37 (3.97) | 28 | 13.902 | 7.73 |
| | | | | | (2.21) | (3.71) |

TABLE 2
GPC and other kinetic results of PS-PAA samples from the 100 g DEE (Example 3) or
Cyclohexane (Example 5), 0.3 g V65, 1.5 g AA, 28.15 g S recipe

| | | | | | Number | Number |
|---|---|---|---|---|---|---|
| | | | | | Average | Average |
| Number of | | | Number | | MW from | MW from |
| of | Wt % | | Average MW | Wt % AA | RI, kD | UV, kD |
| Initiator | AA in | Number Average MW | from UV, kD | in Solid | (PDI) | (PDI) |
| Half | Solid | from RI, kD (PDI) | (PDI) | Solvent - Cyclohexane | | |
| Lives | Solvent - Ether (Example 3 | | | (Ex. 5) | | |
| 0 | | | | | | |
| 1 | 7.9 | 2.35 (2.02) | 0.95 | 21 | 9.099 | 8.535 |
| | | | (3.80) | | (1.86) | (1.96) |
| 2 | | | | | 10.159 | 6.981 |
| | | | | | (1.88) | (2.70) |
| 3 | 18 | 2.95 (2.17) | 1.80 | 15 | 11.251 | 7.129 |
| | | | (2.78) | | (1.93) | (2.90) |
| 4 | | | | | | |
| 5 | 17 | 3.37 (2.34) | 2.13 | 19 | 13.319 | 10.192 |
| | | | (3.07) | | (1.97) | (2.43) |
| 8 | | | | | | |
| 11 | 21 | 4.01 (2.87) | 2.34 | 8.6 | 14.764 | 10.013 |
| | | | (3.94) | | (2.11) | (2.93) |

All the GPC results in Tables 1 and 2 show unimodal peaks. This could indicate relative absence of random S-AA copolymer species. Also, molecular weights from the RI detector measurements are consistently larger than those from UV detector measurements. This indicates the presence of AA in the polymer chains. Finally, the use of cyclohexane resulted in higher molecular weight with less broad MWD than samples from ether-based runs.

From Table 2, one can see that the FRRPP system yielded true ampotheric materials, compared to the equivalent product from the solution system.

### EXAMPLE 6

### Single Stage FRRPP Polymerization of VA/AA Block

Formation of VA/AA copolymer is accomplished by starting with a reactor containing all the monomers and kicking off the reaction by adding the initiator solution. The idea is that most of the AA will react at the early stage and subsequent chain extension will occur with VA addition. The solvent is azeotropic t-butanol/water and initiator is VA-044. These runs were done at reduced amounts of initiator in order to minimize premature termination of AA-containing chains; thus, minimizing the formation of random copolymer.

Two separate polymerizations were performed to produce a block copolymer with 6 wt % AA (B6-1 and B6-2) in a 1-liter glass reactor system. The reactor was initially charged the following reagents: 310.7 g azeotropic t-butanol/water, 2 g AA, and 72.4 g VA. Then, the temperature was raised to 65° C. in 30 minutes while slowly purging the reactor with nitrogen gas. After the operating temperature was reached, the reactor was sealed and the following was added into the reactor fluid for a period of 20 minutes: 0.129 g VA-044 dissolved in 10 g distilled water, 43.3 g azeotropic t-butanol/water. Samples were taken at various points in time, and the steam heater was shut off towards the end of the run. The product was obtained after the reactor fluid cooled to room temperature.

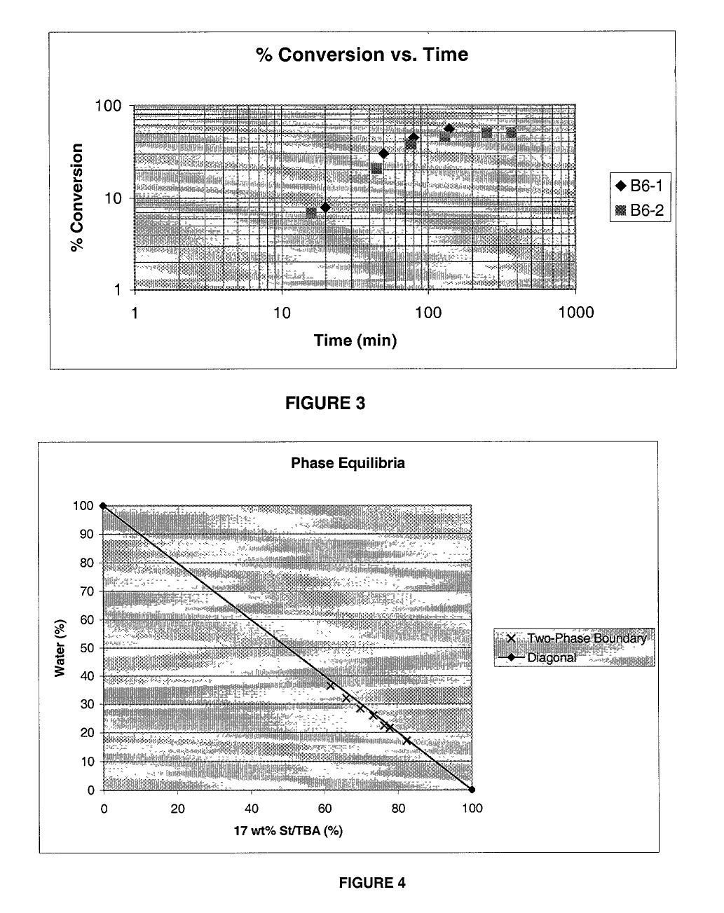

The kinetic data were obtained and plotted in FIG. 3. Time zero corresponds to the time when all initiator was added in. It is worth noting that after 120 minutes (four times VA-044 half life), the conversion-time plot reached an asymptote. This may be due to termination of the chains or existence of relatively unreactive live radicals. The latter possibility is valid because of the relatively high final conversion values of up to 65%. GPC analysis of the B6-1 product indicates a unimodal peak with number average MW of 42 kDaltons and PDI of 2.76.

Differential scanning calorimetry on the blocky B6-1 material indicated glass transition temperatures of 39.5-44.5 and 80.7-90.1° C. This indicates about 64-77 wt % AA in the AA-rich block and 5-11.4 wt % AA in the VA-rich block. Thermogravimetric analysis indicated that this material retained 96% of its weight up to 218.75° C.

### EXAMPLE 7

The polymer of Example 6 was tested for surfactancy behavior. Polymer B6-1 was neutralized by ammonia in water. For an OIW emulsion with an organic phase of 17 wt % styrene in t-butyl acetate, the use of ammonia-neutralized B6-1 revealed relatively large homogenous regions, shown in FIG. 4. This is not surprising because the PVA-rich block of B6-1 has good affinity to the organic phase.

### EXAMPLE 8

### Single Stage FRRPP Polymerization of VA/AA Random Copolymer

In order to produce random VA/AA copolymer, AA was added into the reactor fluid for a longer period of time during the reaction run. The same reactor system and operating conditions were used as that described in Example 6. The reactor initially contained the following: 323.7 g azeotropic t-butanol/water, 3 g AA, and 71.2 g VA. The reactor was heated to the operating temperature of 65° C. for 30 minutes along with a slow nitrogen sweep. When the operating temperature was reached, the reactor was sealed at time zero and the following was added in up to time, t=23 minutes: 0.3046 g VA-044, 10.3 g distilled water, and 45.7 g azeotropic t-butanol/water. At t=31 minutes, the following solution was introduced up to t=2 hrs and 23 minutes: 3.1 g AA, 37.9 g VA, and 82.9 g azeotropic t-butanol/water. The reaction was allowed to continue up to t=8 hrs and 58 minutes. After this time, an air sweep was used to render the reactor fluid nonreactive before the steam heater was turned off while cooling water was used to bring the reactor fluid to room temperature.

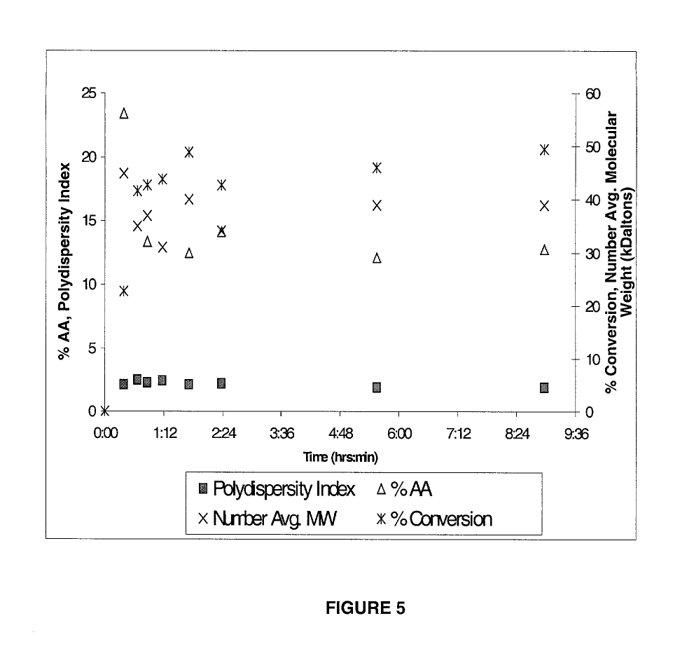

The kinetic data from this experiment is shown in FIG. 5. The experiment was designed to produce a large amount of random copolymer, by continuous addition of AA/VA-044 initiator for 2 hrs and 23 minutes. The GPC traces for each sample were unimodal and the polydispersity index varies from 2.4 (in the beginning) to 1.9 (at the end). The data shown in the figure suggests that this experiment results in about 10-15% AA (using ¹³C NMR) being incorporated in the VA chains. The AA content in the product translates to a random copolymer with a glass transition temperature of about 42° C. This is consistent with the Tg-values obtained of 38° C. using a differential scanning calorimeter.

It is clear from FIG. 5 that after all the initiator (VA-044) has been added at the 2 hr and 24 minute mark, the reaction was well-controlled. In fact, both conversion and number average molecular weight seem to increase in an almost linear fashion.

When the reactor product was coagulated in water with KOH, the coagulum can be drawn into a fibrous material. This is probably due to the development of microcrystalline domains of potassium acrylate in the polymer.

### EXAMPLE 9

### Single Stage FRRPP Polymerization of VA/AA Random

The following were charged into the 1-liter atmospheric reactor system: 288.8 g t-butanol, 2 g AA, and 72.3 g VA, 38.3 g of 0.1-M sodium acetate in water. The reactor was heated to 65° C. in 30 minutes with a slow nitrogen gas sweep on its vapor space. Then, the reactor was sealed and the following was added starting at time, t=0: 0.3059 g VA-044 dissolved in 19.3 g 0.1-M sodium acetate in water, 72.6 g t-butanol. It took up to t=27 minutes to add the initiator-containing solution. At t=16 minutes, the following solution was added in up to t=2 hrs and 46 minutes: 4 g AA, 27.0 g VA, 9.4 g 0.1-M sodium acetate. At t=17 hrs and 57 minutes, the steam was turned off. At t=19 hrs and 13 minutes, the temperature is at 30° C. and the reactor was heated to 65° C. in 1 hr. At t=23 hrs and 11 minutes, steam was turned off again. At t=24 hrs and 24 minutes, the temperature is at 30° C. Here, the following was added in: 1 g AA, 10 g azeotropic t-butanol/water. At t=24 hrs and 54 minutes, the reactor was heated to 65° C. in 30 minutes. At t=25 hrs and 25 minutes the temperature is at 65° C. Air was blown though the surface of the reactor fluid and the reactor was shut down. The solid material from the final product had a 49 wt % AA content (using ¹³C NMR).

### EXAMPLE 10

### Block Copolymer Formation with Rapid Interstage Cooling

First-stage polymerization of styrene in ether (33.4 g styrene, 0.200 g ether, 0.34 g V-65 or AIBN in a 300-ml Parr reactor system) was carried out at 80° C. up to 5 times initiator half life. Then, the reactor fluid was withdrawn through a ⅛-inch Copper tube that is immersed ice-water bath. The cold reactor fluid was collected into a 1000-ml glass reactor that contains 400 ml distilled water and 12 g acrylic acid (AA). The mixture was continuously mixed at room temperature for at least 2 hours in order to soak-in the AA monomer into the polymer-rich domains. Then, the reactor was heated to 60° C. linearly for 4 hrs and maintained at this temperature to drive off the ether and continue the reaction. Aside from conversion and molecular weight data, the products were dried and emulsified in hot water with the addition of ammonia (up to pH=9−10). Upon cooling, the result is a top coagulum, a middle emulsion, and a bottom sludge. The middle emulsion is the material of interest, which should contain mostly PS-P(S-AA) copolymer. Thus, Table 3 shows the results of analysis of the products (SAA1 and SAA2). The results are contrasted with those of the equivalent run where the second-stage M monomer was added in the hot reactor fluid with Pyridine (no interstage rapid cooling to yield the SAA3 product).

TABLE 3
Properties of PS-P(S-AA) products from Example 10 experiments

| | | | | Top:Middle |
|---|---|---|---|---|
| | | | | Emulsion: |
| | | Interstage | | Sludge |
| Product | Initiator | Rapid Cooling? | % Conversion | wt/wt/wt |
| SAA1 | AIBN | Yes | 58 | 2.3:74:23.7 |
| SAA2 | V-65 | Yes | 78 | 2:82:16 |
| SAA3 | AIBN | No | 53 | 0:56:44 |

It is evident that the use of V-65 resulted in an improvement in the amount of middle emulsion layer formed. Also, the interstage cooling seems to improve further the amount of the middle emulsion layer. Since we found that about 20 wt % of the bottom sludge to be emulsifiable in hot water, we can assume that the sludge is mostly polystyrene homopolymer. The top layer could be surmised to be relatively low molecular weight homopolystyrene.

The above results also point to the relatively high proportion of PS radicals that are available for second-stage reaction from styrene polymerization in ether. This high proportion is pegged at the level of about 80%, based on the fact that 82 wt % of solid product was found in the middle emulsion from Table 3. Here, polymer radicals have been made accessible to the second-stage monomer with minimal reaction. This was demonstrated to occur when the first-stage fluid was rapidly cooled before exposure to the second-stage monomer. The fact that a very high amount of emulsifiable material was formed means that the PS radicals were preserved by the rapid cooling and exposure to monomers even at room temperature for up to 2 hrs.

What is claimed is:

1. A copolymer comprising:
a) 4 to 50 percent by weight of (meth)acrylic acid units; and
b) from 50 to 95 percent by weight of at least one non-acid ethylenically unsaturated monomer.

2. The copolymer of claim 1 comprising at least 10 percent by weight of (meth)acrylic acid units.

3. The copolymer of claim 1 comprising at least 15 percent by weight of (meth)acrylic acid units.

4. The copolymer of claim 1 wherein said non-acid ethylenically unsaturated monomer is selected from the group consisting of styrene, vinyl acetate, methyl methacrylate, butyl acrylate, methyl acrylate, acrylonitrile, isopropylacrylamide, and mixtures thereof.

5. The copolymer of claim 1 wherein said copolymer is a block copolymer.

6. The copolymer of claim 1 wherein said polymer is a random copolymer.

7. The copolymer of claim 1 wherein said polymer is a tapered block copolymer.

8. The copolymer of claim 1 wherein said copolymer has a weight average molecular weight of from 1,000 to 100,000.

9. A single stage free radical retrograde precipitation polymerization process for producing a copolymer comprising:
a) admixing
1) a solvent,
2) a free-radical-forming agent,
3) (meth)acrylic acid,
4) and at least one non-acid ethylenically unsaturated monomer;
b) initiating a free-radical precipitation polymerization to form a plurality of polymer radicals;
c) precipitating a copolymer from said polymer radicals;
d) maintaining the admixture of reactants at a temperature above the lower critical solution temperature of said admixture; and
e) controlling the reaction conditions of said admixture to control the rate of propagation of the polymer.

10. The process of claim 9 further comprising a delayed and/or continuous feed of monomer and initiator during the reaction run.

11. The process of claim 9 wherein said non-acid ethylenically unsaturated monomer is selected from the group consisting of selected from the group consisting of styrene, vinyl acetate, methylmethacrylate, butyl acrylate, methyl acrylate, acrylonitrile, and isopropylacrylamide.

12. The process of claim 9 wherein said copolymer is formed from monomers having reactivity ratios between 0.001 and 100.

13. A free radical retrograde precipitation polymerization process for producing a block copolymer comprising:
a) admixing
1) a solvent,
2) a free-radical-forming agent,
3) at least one ethylenically unsaturated monomer;
b) initiating a free-radical precipitation polymerization to form a plurality of polymer radicals;
c) precipitating a polymer from said polymer radicals;
d) maintaining the admixture of reactants at a temperature above the lower critical solution temperature of said admixture;
e) controlling the reaction conditions of said admixture to control the rate of propagation of the polymer;
f) rapidly cooling the reactor contents to below the lower critical solution temperature, following at least 3 times the initiator half life to produce the first monomer into polymer,
g) admixing a second monomer mixture containing at least one ethylenically unsaturated monomer into the cooled reactor contents;
h) heating the reactor contents above the lower critical solution temperature to continue polymerization.

14. The process of claim 13 wherein said rapid cooling occurs by removing the reactor contents through a cooled tube and into a second vessel.
